(19) United States
(12) Patent Application Publication
(10) Pub. No.: US 2024/0223390 A1
(43) Pub. Date: Jul. 4, 2024

(54) BLOCKCHAIN SYSTEM

(71) Applicant: HUAWEI TECHNOLOGIES CO., LTD., Shenzhen (CN)

(72) Inventors: Donghui WANG, Beijing (CN); Fei LIU, Singapore (SG); Wei TAN, Shanghai (CN)

(21) Appl. No.: 18/604,773

(22) Filed: Mar. 14, 2024

Related U.S. Application Data
(63) Continuation of application No. PCT/CN2022/112866, filed on Aug. 16, 2022.

(30) Foreign Application Priority Data
Sep. 15, 2021 (CN) 202111080145.3

(51) Int. Cl. H04L 9/00; H04L 9/08

(52) U.S. Cl. CPC H04L 9/50; H04L 9/0825

(57) ABSTRACT

A method includes sending first information that includes a private key signature of a first blockchain to another apparatus in response to a consensus of another node in the first blockchain network on the first information being successful. The first blockchain includes an apparatus. The second blockchain includes the another apparatus. The method further includes receiving second information that includes a private key signature of the second blockchain network. The second information corresponds to the first information. The method further includes recording the second information on the first blockchain in response to verification on the private key signature of the second blockchain network being successful.

### CROSS-REFERENCE TO RELATED APPLICATIONS

This is a continuation of International Patent Application No. PCT/CN2022/112866, filed on Aug. 16, 2022, which claims priority to Chinese Patent Application No. 202111080145.3, filed on Sep. 15, 2021, the disclosures of the aforementioned applications are hereby incorporated by reference in their entireties.

### TECHNICAL FIELD

The present disclosure relates to the field of data processing technologies, and in particular, to a blockchain system.

### BACKGROUND

A blockchain (BC) is a distributed ledger that integrates a plurality of technologies such as cryptography, a peer to peer (P2P) network, and a distributed database. BC transforms the traditional authority center and centralized trust into a group consensus and decentralized trust, builds a distributed ledger that is protected by cryptography and cannot be tampered with, and has a broad application prospect. Therefore, combining a communication network with a blockchain network is of cross-epoch significance.

Generally, data of a service is usually recorded on one blockchain. However, because there are various service requirements in a communication network, and service data is frequently exchanged, cross-chain interaction usually needs to be performed in a blockchain network in a communication service scenario. Therefore, how to flexibly perform cross-chain interaction in a communication service scenario, form a complete blockchain communication network architecture, and meet various service requirements in a communication network is an urgent problem to be resolved.

### SUMMARY

The present disclosure provides a blockchain system. In some embodiments, by using the blockchain system, a blockchain network may perform cross-chain communication with another blockchain network. Therefore, a complete blockchain communication architecture can be formed in a communication service scenario.

According to a first aspect, the disclosure provides a blockchain system, where the blockchain system includes a first blockchain network and a second blockchain network, the first blockchain network includes at least one first node, and the at least one first node includes a first cross-chain node; the second blockchain network includes at least one second node, and the at least one second node includes a second cross-chain node; and the first blockchain network and the second blockchain network communicate with each other by using the first cross-chain node and the second cross-chain node.

Based on the blockchain system provided in the first aspect, the blockchain network may flexibly perform cross-chain communication with another blockchain network by using a cross-chain node corresponding to the blockchain network. Therefore, a complete blockchain communication architecture can be formed in a communication service scenario.

In some embodiments, the system includes a first blockchain network layer and a second blockchain network layer; the first blockchain network is located at the first blockchain network layer or the second blockchain network layer, the second blockchain network is located at the first blockchain network layer or the second blockchain network layer; and the second blockchain network layer is configured to perform a management operation on the first blockchain network layer, and the management operation includes one or more of registration, snapshot recording, authentication and endorsement, or parameter assignment.

In some embodiments, the first blockchain network is a blockchain network including a terminal device, a network device, or a service server; and the second blockchain network is a consortium blockchain including a node corresponding to an operator, a node corresponding to a service provider, or a node corresponding to a device vendor.

According to a second aspect, the disclosure provides a cross-chain blockchain communication method, where the method is applied to a blockchain system, the blockchain system includes a first blockchain network and a second blockchain network, the first blockchain network includes a first cross-chain node, the second blockchain network includes a second cross-chain node, the first blockchain network and the second blockchain network communicate with each other by using the first cross-chain node and the second cross-chain node, and the method includes: The first cross-chain node broadcasts first information to another node in the first blockchain network; and after a consensus of the another node in the first blockchain network on the first information succeeds, the first cross-chain node sends first information that carries a signature of a private key corresponding to the first blockchain network to the second cross-chain node.

Based on the blockchain cross-chain communication method in the second aspect, the blockchain network may flexibly communicate with a cross-chain node in another blockchain network by using a cross-chain node of the blockchain network. In a communication network with a large quantity of services, a blockchain network corresponding to an associated service may perform service communication by using the blockchain network cross-chain communication method.

In some embodiments, the first cross-chain node receives second information that carries a private key of a signature corresponding to the second blockchain network from the second cross-chain node, where the second information is a response to the first information; and when verification on the signature of the private key corresponding to the second blockchain network succeeds, the first cross-chain node records the second information on a first blockchain. In the manner, communication security is improved during cross-chain communication between blockchain networks.

In some embodiments, the first cross-chain node signs the first information based on a private key of the first blockchain network, to obtain the first information that carries the signature of the private key corresponding to the first blockchain network.

In some embodiments, each node in the first blockchain network corresponds to a private key share of the first blockchain network, and private key shares of all nodes in the first blockchain network are combined into a private key of the first blockchain network; and before that the first cross-chain node sends first information that carries a signature of a private key corresponding to the first blockchain network to the second cross-chain node, the first cross-chain node obtains first information signed by using the private key share corresponding to each node in the first blockchain network, to obtain the first information that carries the signature of the private key corresponding to the first blockchain network. In the manner, when the blockchain network communicates with another blockchain network by using a cross-chain node corresponding to the blockchain network, information is aggregately signed by each node. This further improves communication security.

In some embodiments, the first information is a registration request, the first information carries registration information of the first blockchain network, and the registration information includes one or more of a type of a blockchain network, a chain structure of the blockchain network, a consensus mechanism, a member admission mechanism, a genesis block state, or a smart contract in an effective state on the blockchain network.

In some embodiments, the first information is a snapshot record request, the snapshot record request includes snapshot information of the first blockchain, and the snapshot information includes one or more of a snapshot identifier, a block height represented by a snapshot, a block in which a snapshot exchange is performed, a block hash value of the block, a running node increment, an account status increment, or a smart contract increment.

In some embodiments, the first cross-chain node invokes a smart contract to generate the first information based on one or more of a time period, a block height in the first blockchain, or a block generation speed in the first blockchain.

In some embodiments, the first information is an identity authentication request, and the first cross-chain node receives a verification request sent by a first terminal device, where the verification request is used to verify information about a second terminal device, and the second terminal device is a terminal device that sends a connection request to the first terminal device; the verification request carries a first address that is on the second blockchain and that is of registration information of an authoritative AU institution corresponding to the second terminal device, and a second address that is on the second blockchain and that is of information that the second terminal device is endorsed by the AU institution; and the first cross-chain node generates the identity authentication request based on the verification request.

In some embodiments, the second information is that authentication of the identity authentication request succeeds or authentication of the identity authentication request fails; and the first cross-chain node sends the second information to the first terminal device, so that the first terminal device determines, based on the second information, whether to establish a connection to the second terminal device.

In some embodiments, the first information is authorization management information, and the authorization management information includes a permission parameter of the second blockchain network; and the permission parameter of the second blockchain network is used to determine a parameter range corresponding to a smart contract deployed on the second blockchain network.

According to a third aspect, the disclosure provides a cross-chain blockchain communication method, where the method is applied to a blockchain system, the blockchain system includes a first blockchain network and a second blockchain network, the first blockchain network includes a first cross-chain node, the second blockchain network includes a second cross-chain node, the first blockchain network and the second blockchain network communicate with each other by using the first cross-chain node and the second cross-chain node, and the method includes: The second cross-chain node receives first information that carries a signature of a private key corresponding to the first blockchain network from the first cross-chain node; after verification on the signature of the private key corresponding to the first blockchain network succeeds, the second cross-chain node broadcasts the first information to another node in the second blockchain network; and after a consensus on the first information succeeds, the another node in the second blockchain network records the first information on a second blockchain. For beneficial effects based on the third aspect, refer to beneficial effects of the second aspect. Details are not described herein again.

In some embodiments, the second cross-chain node generates second information based on the first information; the second cross-chain node broadcasts the second information to the another node in the second blockchain network; and after a consensus of the another node in the second blockchain network on the second information succeeds, the second cross-chain node sends second information that carries a signature of a private key corresponding to the second blockchain network to the first cross-chain node.

In some embodiments, before that the second cross-chain node sends second information that carries a signature of a private key corresponding to the second blockchain network to the first cross-chain node, the second cross-chain node signs the second information based on the private key of the second blockchain network, to obtain the second information that carries the signature of the private key corresponding to the second blockchain network.

In some embodiments, each node in the second blockchain network corresponds to a private key share of the second blockchain network, and private key shares of all nodes in the second blockchain network are combined into the private key of the second blockchain network; and before that the second cross-chain node sends second information that carries a signature of a private key corresponding to the second blockchain network to the first cross-chain node, the second cross-chain node obtains second information signed by using the private key share corresponding to each node in the second blockchain network, to obtain the second information that carries the signature of the private key corresponding to the second blockchain network.

According to a fourth aspect, an embodiment of the disclosure provides a node, and the node includes:
a transmission unit, configured to: broadcast first information to another node in a first blockchain network; and after a consensus of the another node in the first blockchain network on the first information succeeds, send first information that carries a signature of a private key corresponding to the first blockchain network to a second cross-chain node.

For beneficial effects based on the fourth aspect, refer to the beneficial effects of the second aspect. Details are not described herein again.

In some embodiments, the transmission unit is further configured to: receive second information that carries a private key of a signature corresponding to a second blockchain network from the second cross-chain node, where the second information is a response to the first information; and when verification on the signature of the private key corresponding to the second blockchain network succeeds, record the second information on a first blockchain. In the manner, communication security is improved during blockchain cross-chain communication.

In some embodiments, the processing unit is further configured to sign the first information based on the private key of the first blockchain network, to obtain the first information that carries the signature of the private key corresponding to the first blockchain network.

In some embodiments, each node in the first blockchain network corresponds to a private key share of the first blockchain network, and private key shares of all nodes in the first blockchain network are combined into the private key of the first blockchain network; and the transmission unit is further configured to obtain first information signed by using the private key share corresponding to each node in the first blockchain network, to obtain the first information that carries the private key signature of the first blockchain network. In the manner, when the blockchain network communicates with another blockchain network by using a cross-chain node corresponding to the blockchain network, information is aggregately signed by each node. This further improves communication security.

In some embodiments, the first information is a registration request, the first information carries registration information of the first blockchain network, and the registration information includes one or more of a type of a blockchain network, a chain structure of the blockchain network, a consensus mechanism, a member admission mechanism, a genesis block state, or a smart contract in an effective state on the blockchain network.

In some embodiments, the first information is a snapshot record request, the snapshot record request includes snapshot information of the first blockchain, and the snapshot information includes one or more of a snapshot identifier, a block height represented by a snapshot, a block in which a snapshot exchange is performed, a block hash value of the block, a running node increment, an account status increment, or a smart contract increment.

In some embodiments, the processing unit is further configured to invoke a smart contract to generate the first information based on one or more of a time period, a block height in the first blockchain, or a block generation speed in the first blockchain.

In some embodiments, the first information is an identity authentication request, and the transmission unit is further configured to receive a verification request sent by a first terminal device, where the verification request is used to verify information about a second terminal device, and the second terminal device is a terminal device that sends a connection request to the first terminal device; the verification request carries a first address that is on the second blockchain and that is of registration information of an authoritative AU institution corresponding to the second terminal device, and a second address that is on the second blockchain and that is of information that the second terminal device is endorsed by the AU institution; and the transmission unit is further configured to send the identity authentication request to the second cross-chain node based on the verification request.

In some embodiments, the second information is that authentication of the identity authentication request succeeds or authentication of the identity authentication request fails; and the first cross-chain node sends the second information to the first terminal device, so that the first terminal device determines, based on the second information, whether to establish a connection to the second terminal device.

In some embodiments, the first information is authorization management information, and the authorization management information includes a permission parameter of the second blockchain network; and the permission parameter of the second blockchain network is used to determine a parameter range corresponding to a smart contract deployed on the second blockchain network.

According to a fifth aspect, the disclosure provides a node, where the node is deployed in a second blockchain network, and the blockchain network includes:
a transmission unit that is configured to receive first information that is from a first cross-chain node and that carries a private key signature of a first blockchain network, where the first information that carries the private key signature of the first blockchain network carries a signature of a private key corresponding to the first blockchain network, and that is further configured to: after verification on the first information that carries the private key signature of the first blockchain network succeeds, broadcast the first information to another node in the second blockchain network; and
a recording unit, configured to: after a consensus of the another node in the second blockchain network on the first information succeeds, store the first information in a second blockchain.

For beneficial effects based on the fifth aspect, refer to the beneficial effects of the third aspect. Details are not described herein again.

In some embodiments, a processing unit is further configured to generate second information based on the first information; the transmission unit is further configured to broadcast the second information to the another node in the second blockchain network; and after a consensus of the another node in the second blockchain network on the second information succeeds, the transmission unit is further configured to send second information that carries a private key signature of the second blockchain network to the first cross-chain node.

In some embodiments, the processing unit is further configured to sign the second information based on a private key of the second blockchain network, to obtain the second information that carries the private key signature of the second blockchain network.

In some embodiments, each node in the second blockchain network corresponds to a private key share of the second blockchain network, and private key shares of all nodes in the second blockchain network are combined into the private key of the second blockchain network; and the processing unit is further configured to obtain second information signed by using the private key share corresponding to each node in the second blockchain network, to obtain the second information that carries the private key signature of the second blockchain network.

According to a sixth aspect, an embodiment of the disclosure further provides a computer device. The computer device may include a memory and a processor. The memory is configured to store a computer program that supports the device in performing the foregoing methods, the computer program includes program instructions, and the processor is configured to invoke the program instructions, to perform the method according to any one of the second aspect or the third aspect.

According to a seventh aspect, an embodiment of the disclosure further provides a computer-readable storage medium, where the computer storage medium stores a computer program, the computer program includes program instructions, and when the program instructions are executed by a processor, the processor is enabled to perform the method according to any one of the second aspect or the third aspect.

According to an eighth aspect, an embodiment of the disclosure further provides a computer program, where the computer program includes computer software instructions, and when the computer software instructions are executed by a computer, the computer is enabled to perform any method according to any one of the second aspect or the third aspect.

According to a ninth aspect, the disclosure further provides a chip, where the chip is configured to implement the method in any possible design of the second aspect or the third aspect.

### BRIEF DESCRIPTION OF DRAWINGS

FIG. 1 is a schematic diagram of a structure of a blockchain system according to an embodiment of the disclosure;

FIG. 2 is a schematic diagram of a structure of another blockchain system according to an embodiment of the disclosure;

FIG. 3 is a schematic diagram of a structure of still another blockchain system according to an embodiment of the disclosure;

FIG. 4 is a schematic flowchart of a blockchain cross-chain communication method according to an embodiment of the disclosure;

FIG. 5 is a schematic flowchart of another blockchain cross-chain communication method according to an embodiment of the disclosure;

FIG. 6a is a schematic flowchart of still another blockchain cross-chain communication method according to an embodiment of the disclosure;

FIG. 6b is a schematic diagram of snapshot information according to an embodiment of the disclosure;

FIG. 7A and FIG. 7B are a schematic flowchart of yet another blockchain cross-chain communication method according to an embodiment of the disclosure;

FIG. 8 is a schematic flowchart of still yet another blockchain cross-chain communication method according to an embodiment of the disclosure;

FIG. 9 is a schematic diagram of a structure of a node according to an embodiment of the disclosure; and

FIG. 10 is a schematic diagram of a structure of a computer device according to an embodiment of the disclosure.

### DETAILED DESCRIPTION

The following clearly and completely describes technical solutions in embodiments of the disclosure with reference to accompanying drawings. It is clear that the described embodiments are merely some but not all embodiments of the disclosure.

In the specification and accompanying drawings of the disclosure, the terms “first”, “second”, and the like are intended to distinguish between different objects or distinguish between different processing of a same object, but are not used to describe a particular order of the objects. In addition, the terms “including”, “having”, or any other variant thereof in descriptions of the disclosure are intended to cover a non-exclusive inclusion. For example, a process, a method, a system, a product, or a device that includes a series of steps or units is not limited to the listed steps or units, but optionally includes other unlisted steps or units, or optionally includes other inherent steps or units of the process, the method, the product, or the device. It should be noted that in embodiments of the disclosure, the word “an example”, “for example”, or the like is used to represent giving an example, an illustration, or a description. Any embodiment or design scheme described as “example” or “for example” in embodiments of the disclosure should not be explained as being more preferred or having more advantages than another embodiment or design scheme. Specifically, use of the words “example” and “for example” is intended to present a relevant concept in a specific way. In embodiments of the disclosure, “A and/or B” represents two meanings: A and B, and A or B. “A, and/or B, and/or C” represents any one of A, B, and C, or represents any two of A, B, and C, or represents A, B, and C. The following describes technical solutions of the disclosure with reference to accompanying drawings.

Some terms in the disclosure are first described, to help a person skilled in the art have a better understanding.

### (1) Blockchain Network

A blockchain network is a network for data sharing between nodes, and the blockchain network may include a plurality of nodes. Each node may receive input information when working normally, and maintain shared data (namely, a blockchain) in the blockchain network based on the received input information. To ensure information communication in the blockchain network, there may be an information connection between nodes, and any two nodes may perform peer to peer (P2P) communication. Specifically, P2P communication may be performed by using a wired communication link or a wireless communication link. For example, when any node in the blockchain network receives input information, another node obtains the input information based on a consensus algorithm, and stores the input information as data in the shared data, so that data stored on all nodes in the blockchain network is consistent.

### 2. Blockchain

Each node in the blockchain network stores a same blockchain. In the disclosure, a blockchain stored by a node in a first blockchain network is referred to as a first blockchain, and a blockchain stored by a node in a second blockchain network is referred to as a second blockchain. A blockchain includes a plurality of blocks. A first block in the blockchain is referred to as a genesis block. The genesis block includes a block header and a block body. The block header stores an input information eigenvalue, a version number, a timestamp, and a difficulty value. The block body stores input information. The genesis block serves as a parent block of a next block of the genesis block, and the next block also includes a block header and a block body. The block header stores an input information eigenvalue of the current block, a block header eigenvalue of the parent block, a version number, a timestamp, and a difficulty value, and so on. In the way, block data stored in each block in the blockchain is associated with block data stored in the parent block. This ensures security of input information in the block.

When each block in the blockchain is generated, a node in which the blockchain is located checks input information when receiving the input information, after completing the check, stores the input information in a memory pool, and updates a hash tree used to record the input information; and then updates an update timestamp to time of receiving the input information, attempts different random numbers, and performs eigenvalue calculation for a plurality of times, so that an eigenvalue obtained through calculation may meet the following formula (1):

SHA256(SHA256(version+prev_hash+merkle_root+ntime+nbits+x))<TARGET (1)

SHA256 is an eigenvalue algorithm used for calculating an eigenvalue; the version (version number) is version information of a related blockchain protocol; prev_hash is a block header eigenvalue of a parent block of a current block; merkle_root is an eigenvalue of input information; ntime is update time of an update timestamp; nbits is a current difficulty that is a fixed value within a period of time and is determined again after a fixed time period; x is a random number; and TARGET is an eigenvalue threshold, and the eigenvalue threshold may be determined based on nbits.

In the way, when a random number that meets the foregoing formula is obtained through calculation, information may be correspondingly stored, and a block header and a block body are generated to obtain the current block. Then, the node in which the blockchain is located sends, based on a node identifier of another node in the blockchain network, a newly generated block to the another node in the blockchain network in which the node is located. The another node checks the newly generated block, and adds the newly generated block to a blockchain stored in the node after the check is completed.

### 3. Smart Contract

A smart contract may run on a node of a blockchain network. A smart contract is code that is executed when a specific condition is met. A developer may define contract logic by using a programming language, and release the contract logic to a blockchain (smart contract registration). The node invokes, based on logic of a contract term, a key or another event to trigger execution, to complete the contract logic, and provides a function of upgrading and deregistering the smart contract.

The following describes in detail blockchain systems and blockchain cross-chain methods provided in the disclosure.

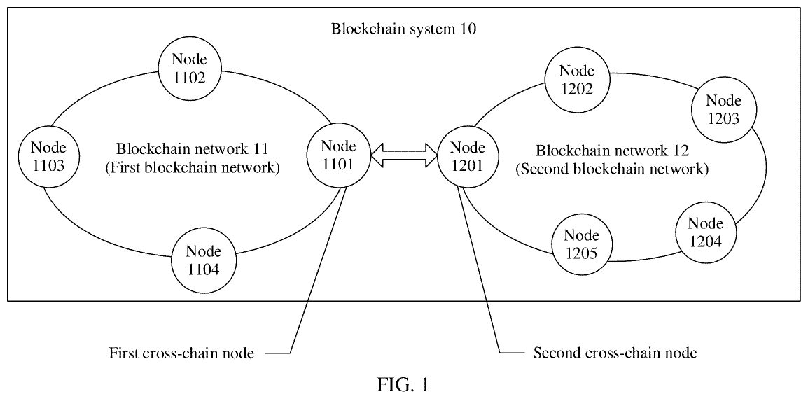

Refer to FIG. 1. FIG. 1 shows a blockchain system 10 according to an embodiment of the disclosure. The blockchain system 10 includes at least two blockchain networks. As shown in FIG. 1, the blockchain system 10 includes a blockchain network 11 and a blockchain network 12. Cross-chain communication may be performed between the blockchain networks in the blockchain system 10. It should be learned that a quantity of blockchain networks included in the blockchain system in FIG. 1 is merely an example, and cannot be considered as a specific limitation on a quantity of blockchain networks included in the blockchain system in the disclosure. To facilitate description of a communication structure between the blockchain networks in the blockchain system 10, the following uses communication between the blockchain network 11 and the blockchain network 12 as an example for description. The blockchain network 11 is a first blockchain network, and the blockchain network 12 is a second blockchain network.

The first blockchain network (e.g. the blockchain network 11) includes at least one first node: a node 1101, a node 1102, a node 1103, and a node 1104. The at least one first node includes a first cross-chain node (e.g. the node 1101). In other words, the blockchain network 11 communicates with the blockchain network 12 by using the node 1101. The second blockchain network (e.g. the blockchain network 12) includes at least one second node: a node 1201, a node 1202, a node 1203, a node 1204, and a node 1205. The at least one second node includes a second cross-chain node (e.g. the node 1201). In other words, the blockchain network 12 communicates with the blockchain network 11 by using the node 1201. In other words, the first blockchain network (e.g. the blockchain network 11) and the second blockchain network (the blockchain network 12) communicate with each other by using the first cross-chain node (e.g. the node 1101) and the second cross-chain node (e.g. the node 1201).

It should be learned that, in the blockchain system shown in FIG. 1, blockchain networks are peer to peer. The first cross-chain node (e.g. the node 1101) and the second cross-chain node (e.g. the node 1201) may communicate with each other by using a cross-chain protocol. In the disclosure, the first cross-chain node belongs to the first blockchain network, and the second cross-chain node belongs to the second blockchain network.

Based on the blockchain system shown in FIG. 1, any blockchain network in the blockchain system may communicate (e.g. exchange data) with another blockchain network in the blockchain system by using a cross-chain node of the blockchain network. In a communication service scenario, one communication service usually corresponds to one blockchain network, and one communication service usually requires data support of a plurality of other communication services. Therefore, by using the blockchain system shown in FIG. 1, the blockchain network may communicate with a plurality of blockchain networks by using a cross-chain node of the blockchain network, to obtain data support of the plurality of other communication services, so as to form a complete blockchain communication architecture in the communication service scenario.

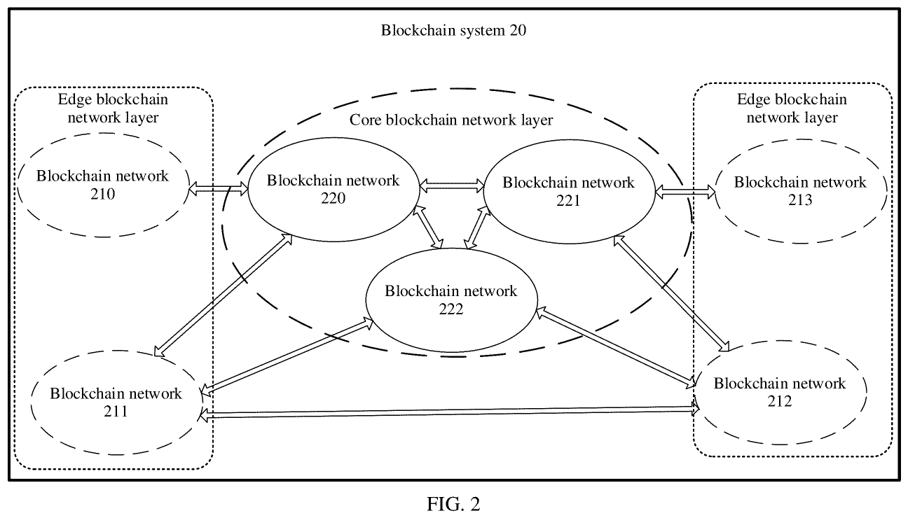

Refer to FIG. 2. FIG. 2 shows another blockchain system according to the disclosure. The blockchain system includes two blockchain layers: an edge blockchain network layer (namely, the foregoing first blockchain network layer) and a core blockchain network layer (namely, the foregoing second blockchain network layer). The core blockchain network layer (namely, the foregoing second blockchain layer) is configured to perform a management operation on the edge blockchain network layer (namely, the foregoing first blockchain network layer). The management operation includes one or more of registration, snapshot recording, authentication and endorsement, or parameter assignment. The edge blockchain network layer includes at least one blockchain network, and the core blockchain network layer includes at least one blockchain network. In the blockchain system shown in FIG. 2, the edge blockchain network layer includes a plurality of blockchain networks: a blockchain network 210, a blockchain network 211, a blockchain network 212, and a blockchain network 213, and the core blockchain network layer includes a plurality of blockchain networks: a blockchain network 220, a blockchain network 221, and a blockchain network 222. It should be learned that, in the blockchain system shown in FIG. 2, a quantity of the blockchain networks included at the edge blockchain network layer and a quantity of the blockchain networks included at the core blockchain network layer are only examples. Specific quantities of blockchain networks included at the edge blockchain network layer and the core blockchain network layer is not specifically limited in the disclosure. Blockchain networks that belong to a same blockchain network layer are peer to peer. For example, if both the blockchain network 220 and the blockchain network 221 belong to the core blockchain network layer, the blockchain network 220 and the blockchain network 221 are peer to peer, and the blockchain network 220 cannot perform a management operation on the blockchain network 221.

In some embodiments, the first blockchain network shown in FIG. 1 may be located at the first blockchain network layer (namely, the edge blockchain network layer), or may be located at the second blockchain network layer (namely, the core blockchain network layer). Alternatively, the second blockchain network may be located at the first blockchain network layer (namely, the edge blockchain network layer), or may be located at the second blockchain network layer (namely, the core blockchain network layer). In other words, when both the first blockchain network and the second blockchain network are located at a same blockchain network layer (the first blockchain network layer or the second blockchain network layer) shown in FIG. 2, cross-chain communication between the first blockchain network and the second blockchain network is cross-chain communication between blockchain networks within the blockchain network layer (e.g. the first blockchain network layer or the second blockchain network layer). When the first blockchain network and the second blockchain network are respectively located at different blockchain network layers shown in FIG. 2 (for example, the first blockchain network is located at the first blockchain network layer, and the second blockchain network is located at the second blockchain network layer; or the first blockchain network is located at the second blockchain network layer, and the second blockchain network is located at the first blockchain network layer), cross-chain communication between the first blockchain network and the second blockchain network is cross-chain communication crossing blockchain network layers.

For example, the first blockchain network is the blockchain network 210 at the edge blockchain network layer, and the second blockchain network is the blockchain network 220 at the core blockchain network layer. The blockchain network 210 performs data exchange (communication) with the blockchain network 220 by using a first cross-chain node of the blockchain network 210, and the blockchain network 220 performs data exchange (communication) with the blockchain network 210 by using a second cross-chain node of the blockchain network 220.

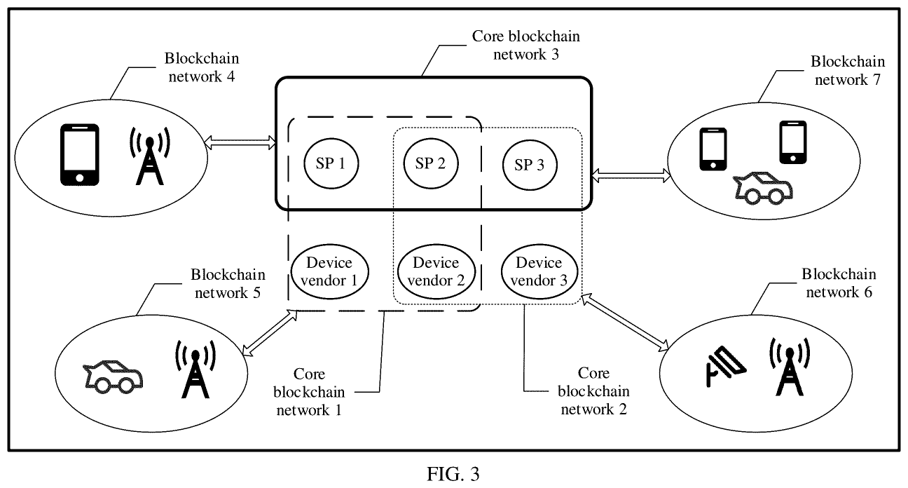

In a communication service scenario, a blockchain system formed by combining the blockchain system shown in FIG. 2 and a telecommunication network is shown in FIG. 3. The core blockchain network layer (namely, the foregoing second blockchain network layer) includes: a core blockchain network 1 constructed by using a service provider (SP) 1, an SP 2, a device vendor 1, and a device vendor 2 as nodes; a core blockchain network 2 constructed by using the SP 2, an SP 3, the device vendor 2, and a vertical industry as nodes; and a core blockchain network 3 constructed by using the SP 1, the SP 2, and the SP 3 as nodes. The edge blockchain network layer (namely, the foregoing first blockchain network layer) includes some small chains established in a small range of a network edge. For example, the edge blockchain network layer includes a blockchain network 4 constructed by a mobile phone device and a base station, a blockchain network 5 constructed by a vehicle and a roadside unit, a blockchain network 6 corresponding to an internet of things (IOT) network, and a blockchain network 7 corresponding to a device to device direct communication (e.g. device to device, D2D) network. These small edge chains and the core blockchain networks form a recording and communication relationship, to jointly support upper-layer communication network services.

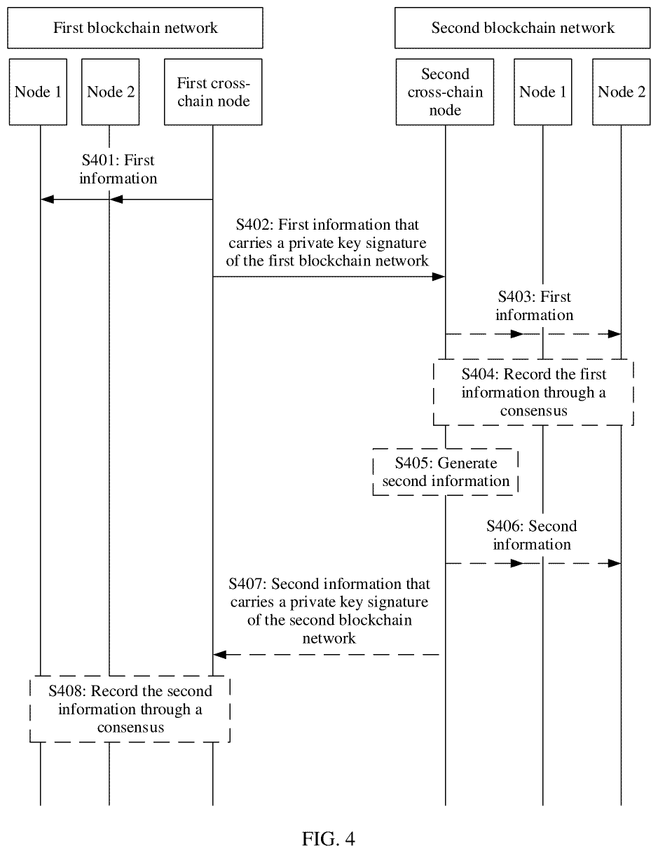

Based on the architecture of the blockchain system provided in FIG. 1, FIG. 2, or FIG. 3, the disclosure provides a blockchain cross-chain communication method. Refer to FIG. 4. FIG. 4 is a schematic flowchart of a blockchain cross-chain communication method according to an embodiment of the disclosure. The method is applied to the blockchain system provided in FIG. 1, FIG. 2, or FIG. 3. The blockchain system includes a first blockchain network and a second blockchain network, the first blockchain network includes a first cross-chain node, the second blockchain network includes a second cross-chain node, and the first blockchain network and the second blockchain network communicate with each other by using the first cross-chain node and the second cross-chain node. The blockchain cross-chain communication method includes S401 and S402.

S401: The first cross-chain node broadcasts first information to another node in the first blockchain network.

The first blockchain network includes a plurality of nodes: common nodes (namely, a node 1 and a node 2 in the first blockchain network in FIG. 4) and the first cross-chain node. The first information may be generated by the first cross-chain node or may be obtained from another device (a device that has a communication connection to the first cross-chain node). This is not specifically limited in the disclosure.

The first cross-chain node signs the first information based on a private key of the first cross-chain node, to obtain first information that carries a private key signature of the first cross-chain node, and broadcasts the first information that carries the private key signature of the first cross-chain node to the another node in the first blockchain network (namely, the node 1 and the node 2 in the first blockchain network in FIG. 4).

S402: After a consensus of the another node in the first blockchain network on the first information succeeds, the first cross-chain node sends first information that carries a private key signature of the first blockchain network to the second cross-chain node.

After verification on the private key signature of the first cross-chain node based on a public key of the first cross-chain node succeeds, each common node in the first blockchain network updates (or records) the first information on a first blockchain through a consensus. After the consensus of the another node in the first blockchain network on the first information succeeds, the first cross-chain node obtains the first information that carries the private key signature of the first blockchain network, and sends the first information that carries the private key signature of the first blockchain network to the second cross-chain node.

In some embodiments, a specific manner in which the first cross-chain node obtains the first information that carries the private key signature of the first blockchain network may include the following two manners:
Manner 1: The first cross-chain node may directly sign the first information by using a private key of the first blockchain network, to obtain the first information that carries the private key signature of the first blockchain network.
Manner 2: Each node in the first blockchain network corresponds to a private key share of the first blockchain network, and private key shares of all nodes in the first blockchain network are combined into a private key of the first blockchain network. In other words, the private key of the first blockchain network is divided into a plurality of private key shares. A quantity of private key shares is the same as a quantity of nodes (the common nodes and the first cross-chain node) in the first blockchain network. The nodes in the first blockchain network are in a one-to-one correspondence with the private key shares. In the case, for each node in the first blockchain network, after receiving first information from the first cross-chain node and successfully verifying the first information, the node signs the first information by using a private key share corresponding to the node. After each node in the first blockchain network signs the first information by using the private key share corresponding to the node, the first cross-chain node obtains the first information that is signed by using the private key share corresponding to each node in the first blockchain network, to obtain the first information that carries the private key signature of the first blockchain network.

Based on the blockchain cross-chain communication method provided in FIG. 4, a blockchain network may flexibly perform cross-chain communication with another blockchain network by using a cross-chain node of the blockchain network.

In an application scenario, after the first cross-chain node sends the first information that carries the private key signature of the first blockchain network to the second cross-chain node in the second blockchain network, the second cross-chain node may send second information that carries a private key signature of the second blockchain network to the first cross-chain node based on the first information, where the second information is a response to the first information. In the scenario, the cross-chain blockchain communication method provided in FIG. 4 may further include S403 to S408.

S403: After verification on the private key signature of the first blockchain network succeeds, the second cross-chain node broadcasts the first information to another node in the second blockchain network.

The second blockchain network includes a plurality of nodes: common nodes (namely, a node 1 and a node 2 in the second blockchain network in FIG. 4) and the second cross-chain node. After the second cross-chain node receives the first information that carries the private key signature of the first blockchain network from the first cross-chain node, the second cross-chain node verifies the private key signature of the first blockchain network based on a public key of the first blockchain network, and after the verification succeeds, the second cross-chain node signs the first information based on a private key of the second cross-chain node, to obtain first information that carries a private key signature of the second cross-chain node, and broadcasts the first information that carries the private key signature of the second cross-chain node to other nodes (namely, the node 1 and the node 2 in the second blockchain network in FIG. 4) in the second blockchain network.

S404: After a consensus of the other nodes in the second blockchain network on the first information succeeds, the second cross-chain node records the first information in the second blockchain network.

After verification on the private key signature of the second cross-chain node based on a public key of the second cross-chain node succeeds, each common node in the second blockchain network records (or updates) the first information on a second blockchain through a consensus.

S405: The second cross-chain node generates the second information based on the first information.

The second cross-chain node responds to the first information, to generate the second information. That is, the second information may be understood as response information corresponding to the first information.

S406: The second cross-chain node broadcasts the second information to the other nodes in the second blockchain network.

The second cross-chain node signs the second information based on the private key of the second cross-chain node, to obtain second information that carries a private key signature of the second cross-chain node, and broadcasts the second information that carries the private key signature of the second cross-chain node to the other nodes (namely, the node 1 and the node 2 in the second blockchain network in FIG. 4) in the second blockchain network.

S407: After a consensus of the other nodes in the second blockchain network on the second information succeeds, the second cross-chain node sends second information that carries a private key signature to the second blockchain network to the first cross-chain node.

After verification on the private key signature of the second cross-chain node based on the public key of the second cross-chain node succeeds, each common node in the second blockchain network records (or updates) the second information on a second blockchain through a consensus. Further, the second cross-chain node obtains the second information that carries the private key signature of the second blockchain network, and sends the second information that carries the private key signature of the second blockchain network to the first cross-chain node.

In some embodiments, a specific manner in which the second cross-chain node obtains the second information that carries the private key signature of the second blockchain network may include the following two manners:
Manner 1: The second cross-chain node may directly sign the second information by using a private key of the second blockchain network, to obtain the second information that carries the private key signature of the second blockchain network.
Manner 2: Each node in the second blockchain network corresponds to a private key share of the second blockchain network, and private key shares of all nodes in the second blockchain network are combined into a private key of the second blockchain network. In other words, the private key of the second blockchain network is divided into a plurality of private key shares. A quantity of private key shares is the same as a quantity of nodes (the common nodes and the second cross-chain node) in the second blockchain network. The nodes in the second blockchain network are in a one-to-one correspondence with the private key shares. In the case, for each node in the second blockchain network, after receiving second information broadcast by the second cross-chain node and successfully verifying the second information, the node signs the second information by using a private key share corresponding to the node. After each node in the second blockchain network signs the second information by using the private key share corresponding to the node, the second cross-chain node obtains the second information that is signed by using the private key share corresponding to each node in the second blockchain network, to obtain the second information that carries the private key signature of the second blockchain network.

S408: When verification on the private key signature of the second blockchain network succeeds, the first cross-chain node records the second information on the first blockchain.

After receiving the second information that carries the private key signature of the second blockchain network from the second cross-chain node, the first cross-chain node verifies the private key signature of the second blockchain network based on a public key of the second blockchain network. When the verification succeeds, the first cross-chain node broadcasts the second information to another node in the first blockchain network, and records the second information on the first blockchain network through a consensus.

Based on the blockchain cross-chain communication method shown in FIG. 4, the first cross-chain node communicates with the second cross-chain node, so that data exchange can be performed between the first blockchain network and the second blockchain network. In a communication service scenario, two blockchain networks of different services may exchange data in such a cross-chain communication manner. This can construct a complete communication system architecture, to meet a service requirement of mutual support of data services in a communication system, and improve data security in the communication service scenario.

With reference to specific content of the first information and the second information, the following describes the cross-link blockchain communication method by using examples.

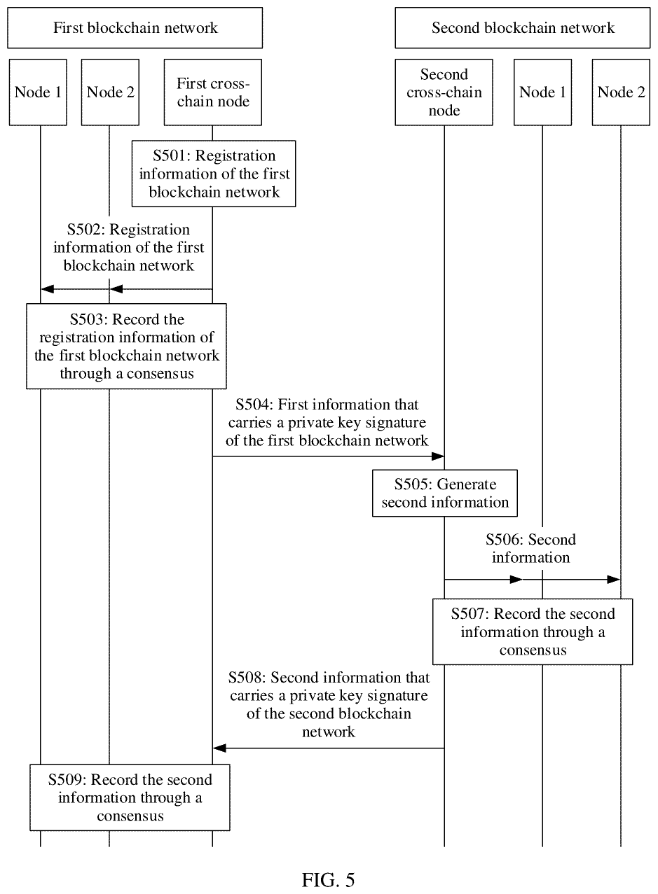

In an application scenario, the first information is a registration request, the registration request is used to add the first blockchain network to the blockchain system, and the first information carries registration information of the first blockchain network. Refer to FIG. 5. FIG. 5 is a schematic flowchart of another blockchain cross-chain communication method according to an embodiment of the disclosure. The blockchain cross-chain communication method shown in FIG. 5 describes an execution procedure in which an edge blockchain network (which may be understood as a first blockchain network) joins a blockchain system and registers with a core blockchain network (which may be understood as a second blockchain network). The procedure specifically includes S501 to S509. In the blockchain cross-chain communication method shown in FIG. 5, the edge blockchain network is considered as a first blockchain, and the core blockchain network is considered as a second blockchain.

It should be noted that a cross-chain node in the disclosure is a node on which a cross-chain program is deployed and that is in a blockchain network, or a cross-chain node is a common node that can perform communication by using a separate cross-chain agent or cross-chain router. Unless otherwise specified, the same is true in the specification.

S501: A first cross-chain node in the first blockchain network (namely, the edge blockchain network) generates registration information of the first blockchain network.

The first cross-chain node may invoke a smart contract deployed on the first blockchain network, to generate the registration information of the first blockchain network, and the registration information includes one or more of a type of a blockchain network, a chain structure of the blockchain network, a consensus mechanism, a member admission mechanism, a genesis block state, or a smart contract in an effective state on the blockchain network. The type of the blockchain network includes a consortium chain, a public chain, or a private chain. The chain structure of the blockchain network includes a single chain, a plurality of parachains, a directed acyclic graph (DAG), or a mountable blockchain. The consensus mechanism includes a proof of work (POW), a proof of stake (POS), a delegated proof of stake (DPOS), and practical Byzantine fault tolerance (PBFT). The member admission mechanism may be understood as a condition of a node in the first blockchain network. The genesis block state is information about the first block in the first blockchain. The smart contract in an effective state may be understood as information about a smart contract that can be further invoked in the first blockchain network currently.

S502: The first cross-chain node broadcasts the registration information to another node in the first blockchain network.

The first cross-chain node performing hashing on the registration information, and signs a hash result by using a private key of the first cross-chain node, to obtain registration information that carries a private key signature of the first cross-chain node. A form of the registration information that carries the private key signature of the first cross-chain node may be {registration information, a registration information hash value, a signature obtained by using the private key of the first cross-chain node to hash the registration information}.

S503: After the another node in the first blockchain network successfully verifies the registration information, the first cross-chain node records the registration information on a first blockchain through a consensus.

After receiving the registration information that carries the private key signature of the first cross-chain node, the another node of the first blockchain network verifies the private key signature of the first cross-chain node based on a public key of the first cross-chain node. When the verification succeeds, each node in the first blockchain network records the registration information on the first blockchain through a consensus.

S504: The first cross-chain node sends first information that carries a private key signature of the first blockchain network to a second cross-chain node.

The first information that carries the private key signature of the first blockchain network includes registration information, an address that is of the registration information and that is recorded in the first blockchain network, and the private key signature of the first blockchain network.

S505: After verification on the first information succeeds, the second cross-chain node generates second information.

The second cross-chain node verifies the private key signature of the first blockchain network in the first information based on a public key of the first blockchain network. After the verification succeeds, the second cross-chain node verifies the registration information included in the first information and the address that is of the registration information and that is in the first blockchain network. A specific verification manner may be verifying a hash value of the first information. After verification on the first information succeeds, the second cross-chain node invokes a smart contract deployed on the second blockchain network, and the registration information and the address that is of the registration information and that is in the first blockchain network are used as input to generate the second information.

S506: The second cross-chain node broadcasts the second information to another node in the second blockchain network.

For a specific implementation of S506, refer to the specific implementation of S406. Details are not described herein again.

S507: After a consensus of the another node in the second blockchain network on the second information succeeds, record the second information on a second blockchain.

After verification on the private key signature of the second cross-chain node based on a public key of the second cross-chain node succeeds, each common node in the second blockchain network records (or updates) the second information on a second blockchain through a consensus.

S508: The second cross-chain node sends second information that carries a private key signature of the second blockchain network to the first cross-chain node.

The second information includes an address that is of the registration information and that is in the second blockchain network and the private key signature of the second blockchain network. For a specific manner in which the second cross-chain node obtains the second information signed by using a private key of the second blockchain network, refer to the specific manner in S407. Details are not described herein again.

S509: When verification on the private key signature of the second blockchain network succeeds, the first cross-chain node records the second information on the first blockchain.

After receiving the second information that carries the private key signature of the second blockchain network from the second cross-chain node, the first cross-chain node verifies the private key signature of the second blockchain network based on a public key of the second blockchain network. When the verification succeeds, the first cross-chain node broadcasts the second information to another node in the first blockchain network, and records the second information on the first blockchain network through a consensus. A process that first blockchain network registers with the second blockchain network is completed, and the first blockchain network joins the blockchain system.

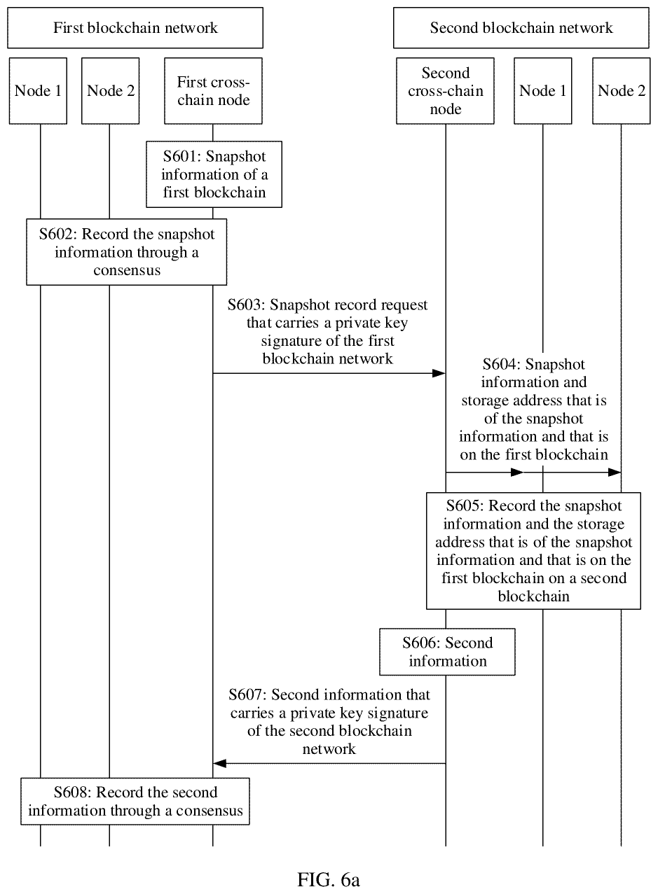

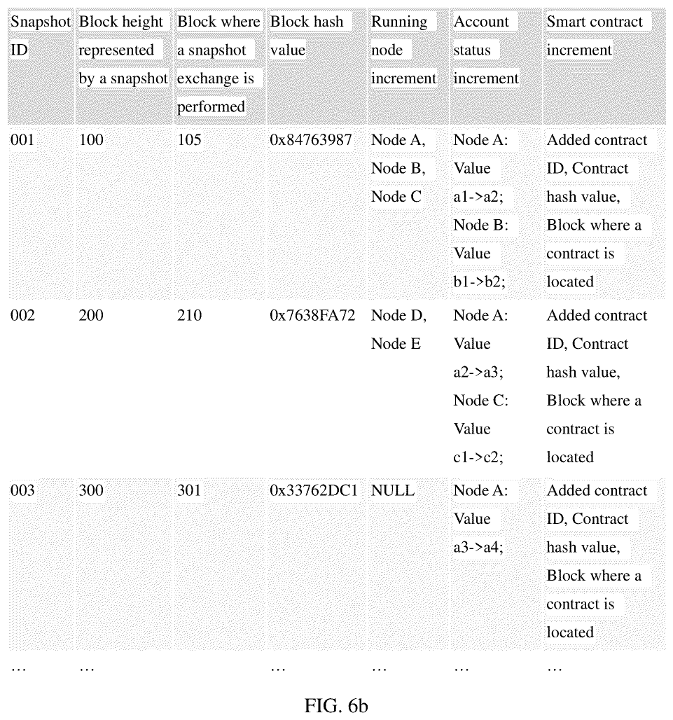

In another application scenario, the first information is a snapshot record request, and the snapshot record request includes snapshot information of a first blockchain. Refer to FIG. 6a. FIG. 6a is a schematic flowchart of still another blockchain cross-chain communication method according to an embodiment of the disclosure. The blockchain cross-chain communication method shown in FIG. 6a describes an execution procedure in which an edge blockchain network records snapshot information of the edge blockchain network to a core blockchain network. The procedure specifically includes S601 to S608. In the blockchain cross-chain communication method shown in FIG. 6a, the edge blockchain network is considered as a first blockchain network, and the core blockchain network is considered as a second blockchain network.

S601: A first cross-chain node generates snapshot information of a first blockchain, and broadcasts the snapshot information to another node in a first blockchain network.

The snapshot information includes one or more of a snapshot identifier, a block height represented by a snapshot, a block in which a snapshot exchange is performed, a block hash value of the block, a running node increment, an account status increment, or a smart contract increment. For example, refer to FIG. 6b. FIG. 6b is a schematic diagram of snapshot information according to the disclosure. The snapshot information includes a snapshot identifier, a block height represented by a snapshot, a block in which a snapshot exchange is performed, a block hash value of the block, a running node increment, an account status increment, or a smart contract increment.

The first cross-chain node generates the snapshot information of the first blockchain according to a snapshot information generation rule. Further, the first cross-chain node broadcasts the snapshot information to the another node in the first blockchain network, so that the another node in the first blockchain network has a consensus on the snapshot information.

A specific snapshot information generation rule for generating snapshot information by the first cross-chain node is described below as an example.

In some embodiments, the first cross-chain node may generate the snapshot information based on a time period. For example, the time period is 24 hours, and at a moment at an interval of 24 hours from a generation moment of a previous piece of snapshot information, the first cross-link node invokes a smart contract related to snapshot information to generate the snapshot information. That is, it may be understood that a time interval between generating two pieces of adjacent snapshot information by the first cross-chain node is 24 hours.

In some embodiments, the first cross-chain node may generate first information based on a block height in the first blockchain. For example, at a generation moment of a previous piece of snapshot information, a block height of the first blockchain is 100. When it is detected that a block height of the first blockchain is 200, the first cross-chain node invokes a smart contract related to snapshot information to generate the snapshot information. That is, it may be understood as that the snapshot information is generated with a block height interval of 100.

In some embodiments, the first cross-chain node may generate first information based on a block generation speed on the first blockchain. For example, a smart contract of the first blockchain network specifies that a block height interval between two pieces of adjacent snapshot information is 100. In the case, if it is detected after a previous piece of snapshot information is generated that a block generation speed is one block every 10 minutes, the first cross-chain node may generate the snapshot information after 1000 minutes. If it is detected after the previous piece of snapshot information is generated that a block generation speed is one block every 20 minutes, the first cross-chain node may generate the snapshot information after 2000 minutes.

S602: After a consensus of the another node in the first blockchain network on the snapshot information succeeds, record the snapshot information on the first blockchain.

The another node in the first blockchain network receives the snapshot information from the first cross-chain node, and after verification on the snapshot information succeeds, records the snapshot information on the first blockchain through a consensus.

S603: The first cross-chain node sends a snapshot record request that carries a private key signature of the first blockchain network to a second cross-chain node.

The first cross-chain node generates the snapshot record request based on the snapshot information and a storage address that is of the snapshot information and that is on the first blockchain, where the snapshot record request is used to request the second blockchain network to record the snapshot information of the first blockchain. Further, the first cross-chain node obtains the snapshot recording request that carries the private key signature of the first blockchain network. For a specific manner in which the first cross-chain node obtains the snapshot recording request that carries the private key signature of the first blockchain network, refer to the two specific manners in which the first cross-chain node obtains the first information that carries the private key signature of the first blockchain network in S402. Details are not described herein again.

S604: After verification on the snapshot recording request that carries the private key signature of the first blockchain network succeeds, the second cross-chain node broadcasts the snapshot information and the storage address that is of the snapshot information and that is on the first blockchain to another node in the second blockchain network.

The second cross-chain node receives the snapshot record request that carries the private key signature of the first blockchain network from the first cross-chain node. Further, the second cross-chain node verifies the private key signature of the first blockchain network based on a public key of the first blockchain network. After the verification succeeds, the second cross-chain node verifies whether the first blockchain network has uploaded the snapshot information (which may be understood as verifying whether the storage address that is of the snapshot information and that is on the first blockchain is correct). After the verification succeeds, the second cross-chain node broadcasts the snapshot information and the storage address that is of the snapshot information and that is on the first blockchain to the another node.

S605: After a consensus of the another node in the second blockchain network on the snapshot information and the storage address that is of the snapshot information and that is on the first blockchain succeeds, the second cross-chain node records the snapshot information and the storage address that is of the snapshot information and that is on the first blockchain on a second blockchain.

After receiving the snapshot information from the second cross-chain node and the storage address that is of the snapshot information and that is on the first blockchain, the another node in the second blockchain network has a consensus on the snapshot information and the storage address that is of the snapshot information and that is on the first blockchain, and after the consensus succeeds, records the snapshot information and the storage address that is of the snapshot information and that is on the first blockchain on the second blockchain.

S606: The second cross-chain node generates second information based on the first information.

The second cross-chain node generates the second information based on a storage address that is of “the snapshot information and the storage address that is of the snapshot information and that is on the first blockchain” and that is on the second blockchain. That is, the second information includes the storage address that is of “the snapshot information and the storage address that is of the snapshot information and that is on the first blockchain” and that is on the second blockchain.

S607: The second cross-chain node sends second information that carries a private key signature of the second blockchain network to the first cross-chain node.

For details about obtaining, by the second cross-chain node, the second information that carries the private key signature of the second blockchain network, refer to the two specific manners in which the second cross-chain node obtains the second information that carries the private key signature of the second blockchain network in S407. Details are not described herein again.

S608: When verification on the private key signature of the second blockchain network succeeds, the first cross-chain node records the second information on the first blockchain.

After the first cross-chain node receives the second information that carries the private key signature of the second blockchain network, the first cross-chain node verifies the private key signature of the second blockchain network based on a public key of the second blockchain network. When the verification succeeds, the first cross-chain node broadcasts the second information to the another node in the first blockchain network, so that the another node in the first blockchain network has a consensus on the second information, and records the second information on the first blockchain through a consensus.

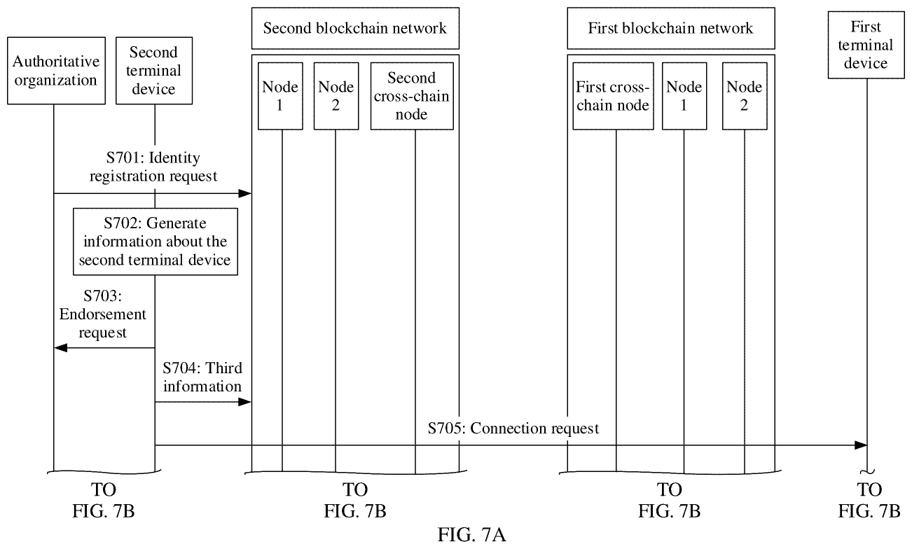

In still another application scenario, the first information is an identity authentication request. Refer to FIG. 7A and FIG. 7B. FIG. 7A and FIG. 7B are a schematic flowchart of yet another blockchain cross-chain communication method according to an embodiment of the disclosure. The blockchain cross-chain communication method shown in FIG. 7A and FIG. 7B describes an identity authentication procedure based on a cross-chain mutual trust relationship. The procedure specifically includes S701 to S711. A first terminal device is a user of a first blockchain network, and a second terminal device is a user of a second blockchain network.

S701: An authoritative organization (AU) sends an identity registration request to the second blockchain network.

It may be understood that the AU sends the identity registration request to any node in the second blockchain network. The identity registration request includes information about the AU (namely, an identifier or a public key of the AU), and the identity registration request is used to request the node in the second blockchain network to record the information about the AU in a first address of a second blockchain. It should be noted that the AU includes but is not limited to a certificate issuing authority (Certification Authority, CA), a government department, a functional department, and the like.

S702: The second terminal device generates information about the second terminal device.

The information about the second terminal device includes identifier information of the second terminal device, a public key of the second terminal device, and to-be-proved information corresponding to the second terminal device. For example, the to-be-proved information may prove that a user corresponding to the second terminal device is already 18 years old.

S703: The second terminal device sends an endorsement request to the AU, where the endorsement request is used to request the AU to sign the information about the second terminal device.

The second terminal device sends the endorsement request to the AU, where the endorsement request carries the information about the second terminal device, and the endorsement request is used to request the AU to sign the information about the second terminal device, or may be understood as that the AU issues a digital certificate for the information about the second terminal device. For example, a form of the endorsement request may be {the identifier of the second terminal device, the public key of the second terminal device, and the to-be-proved information corresponding to the second terminal device}. The AU verifies the information about the second terminal device. After the verification succeeds, the AU signs the information about the second terminal device based on a private key of the AU. That is, it may be understood that the AU issues a digital certificate to the second terminal device, to prove that the information about the second terminal device passes the verification performed by the AU.

S704: The second terminal device sends third information to the second blockchain network, where the third information includes the information about the second terminal device and an AU private key signature for the information about the second terminal device.

It may be understood that the second terminal device sends the third information to any node in the second blockchain network. After receiving the third information, the node verifies the AU private key signature in the third information based on the AU public key. After the verification succeeds, the second blockchain node stores the information about the second terminal device in a second address on the second blockchain. Further, the node sends response information to the second terminal device, where the response information carries an identifier of the second blockchain network and the first address at which registration information of the AU is stored on the second blockchain, and the information about the second terminal device is stored in the second address on the second blockchain.

S705: The second terminal device sends a connection request to the first terminal device, where the connection request carries the information about the second terminal device, the identifier of the second blockchain network, the first address at which the registration information of the AU is stored on the second blockchain, and the second address at which the to-be-proved information corresponding to the second terminal device is stored on the second blockchain.

S706: The first terminal device sends a verification request to a node in the first blockchain network based on the connection request, where the verification request is used to verify the information about the second terminal device.

The verification request carries the identifier of the second blockchain, the first address at which the registration information of the AU corresponding to the second terminal device is stored on the second blockchain, and the second address at which the information about the second terminal device (which includes the information (namely, to-be-proved information of the second terminal device) endorsed by the AU) is stored on the second blockchain.

S707: After a consensus of the node in the first blockchain network on the authentication request succeeds, a first cross-chain node sends an identity authentication request that carries a private key signature of the first blockchain network to a second cross-chain node.

The node (which is the node that receives the connection request of the first terminal device) broadcasts the verification request to another node in the first blockchain network, and records the verification request on the first blockchain through a consensus. Further, the first cross-chain node sends the identity authentication request that carries the private key signature of the first blockchain network to the second cross-chain node. For a manner in which the first cross-chain node obtains the identity authentication request that carries the private key signature of the first blockchain network, refer to the foregoing two specific manners in S402 in which the first cross-chain node obtains the first information that carries the private key signature of the first blockchain network. Details are not described herein again. The identity authentication request includes the first address at which the registration information of the AU is stored on the second blockchain, and the second address at which the information about the second terminal device (which includes the information (namely, to-be-proved information of the second terminal device) endorsed by the AU) is stored on the second blockchain.

S708: The second cross-chain node generates second information based on the identity authentication request, and sends the second information that carries a second blockchain private key signature to the first cross-chain node.

After receiving the identity authentication request, the second cross-chain node verifies, based on a cross-chain query mechanism, the first address at which the registration information that is of the AU and that is carried in the identity authentication request is stored on the second blockchain, and the second address at which the information (namely, the to-be-proved information of the second terminal device) that is about the second terminal device and that is endorsed by the AU is stored on the second blockchain, to verify whether the first address stores the registration information of the AU, and whether the second address stores the information (namely, to-be-proved information of the second terminal device) that is about the second terminal device and that is endorsed by the AU. When the verification succeeds, the second cross-chain node generates the second information, where the second information is that authentication of the identity authentication request succeeds. When the registration information of the AU is not found in the first address or the information (that is, the to-be-proved information of the second terminal device) that is about the second terminal device and that is endorsed by the AU is not found in the second address, the second cross-chain node generates the second information, where the second information is that authentication of the identity authentication request fails.

S709: The first cross-chain node verifies the second information that carries the private key signature of the second blockchain network, and after the verification succeeds, records the second information on the first blockchain through a consensus.

The first cross-chain node verifies the private key signature of the second blockchain network based on a public key of the second blockchain network. When the verification succeeds, the first cross-chain node initiates a consensus on the second information to another node in the first blockchain network. After the consensus succeeds, the second information is recorded on the first blockchain.

S710: The node in the first blockchain network sends the second information to the first terminal device.

The first terminal device receives the second information sent by the node of the first blockchain network, and determines, based on the second information, that the first terminal device establishes a connection to the second terminal device.

In some embodiments, when the second information is that authentication of the identity authentication request succeeds, the second information further includes the registration information of the AU and the information (namely, the to-be-proved information of the second terminal device) that is of the second terminal device and that is endorsed by the AU.

S711: When the second information is that authentication of the identity authentication request succeeds, the first terminal device connects to the second terminal device based on the second information.

In another possible implementation, when the second information is that authentication of the identity authentication request fails, the first terminal device rejects, based on the second information, to connect to the second terminal device.

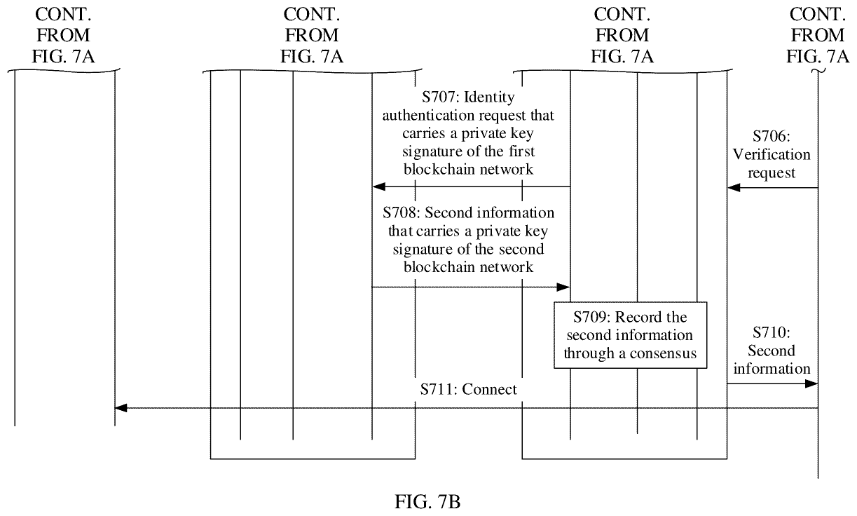

In yet another application scenario, the first information is authorization management information, the authorization management information includes a permission parameter of an edge blockchain network, and the permission parameter of the edge blockchain network is used to determine a parameter range corresponding to a smart contract deployed on the edge blockchain network. Refer to FIG. 8. FIG. 8 is a schematic flowchart of still yet another blockchain cross-chain communication method according to an embodiment of the disclosure. FIG. 8 shows a resource authorization procedure performed by a core blockchain network to an edge blockchain network. The procedure includes S801 and S802. In the blockchain cross-chain communication method shown in FIG. 8, the core blockchain network is considered as a first blockchain network, and the edge blockchain network is considered as a second blockchain network.

S801: The first cross-chain node sends authorization management information that carries a private key signature of a first blockchain network to the second cross-chain node.

A node of the first blockchain network (the core blockchain network) determines the authorization management information for the second blockchain network (the edge blockchain network). Specifically, a node in the first blockchain network (the core blockchain network) may determine the authorization management information of the second blockchain network (the edge blockchain network) based on service content of the second blockchain network (the edge blockchain network). Further, the node broadcasts the authorization management information to another node in the first blockchain network (the core blockchain network). After a consensus of the another node in the first blockchain network (the core blockchain network) on the authorization management information succeeds, the node records the authorization management information on a first blockchain (a core blockchain).

For example, an authorization frequency band range corresponding to the first blockchain network (the core blockchain network) is 10 MHz to 100 MHZ, and the second blockchain network (the edge blockchain network) is a blockchain network corresponding to an IoT service. In the case, the first cross-chain node in the first blockchain network (the core blockchain network) determines that an authorization frequency band range of the second blockchain network (the edge blockchain network) is 10 MHz to 50 MHZ, that is, authorization management information of the second blockchain network (the edge blockchain network) is 10 MHz to 50 MHz. The first cross-chain node broadcasts the authorization management information of the second blockchain network (the edge blockchain network) to another node in the first blockchain network, and after a consensus succeeds, records the authorization management information (10 MHz to 50 MHz) of the second blockchain network (the edge blockchain network) on the first blockchain.

S802: After verifying the authorization management information that carries the private key signature of the first blockchain network, the second cross-chain records the authorization management information on the second blockchain through a consensus.

The second cross-chain node verifies the private key signature of the first blockchain network based on a public key of the first blockchain network. After the verification succeeds, the second cross-chain node uploads the authorization management information according to an inter-chain protocol, and limits a parameter range of a smart contract deployed on the second blockchain network. For example, when the authorization management information is that an authorization frequency band permission of the second blockchain network is 10 MHz to 50 MHz, a parameter range of a smart contract that is related to an authorization frequency band and that is deployed on the second blockchain network is defined to be 10 MHz to 50 MHz based on the authorization management information.

Further, when a node in the second blockchain network needs to invoke the smart contract, the node first checks whether a parameter for invoking the smart contract is within the parameter range. When the parameter is beyond the parameter range, the node in the second blockchain network does not pass the check. For example, the authorization frequency band permission of the second blockchain network is 10 MHz to 50 MHz. When an input parameter that is for invoking the smart contract and that is received by the node in the second blockchain network is 60 MHz, the node in the second blockchain network rejects to invoke the smart contract.

It can be learned that, by using the blockchain cross-chain communication method shown in FIG. 8, the core blockchain network can perform authorization management on the edge blockchain network.

The foregoing describes the method in the embodiments of the disclosure in detail. The following provides a related apparatus in the embodiments of the disclosure.

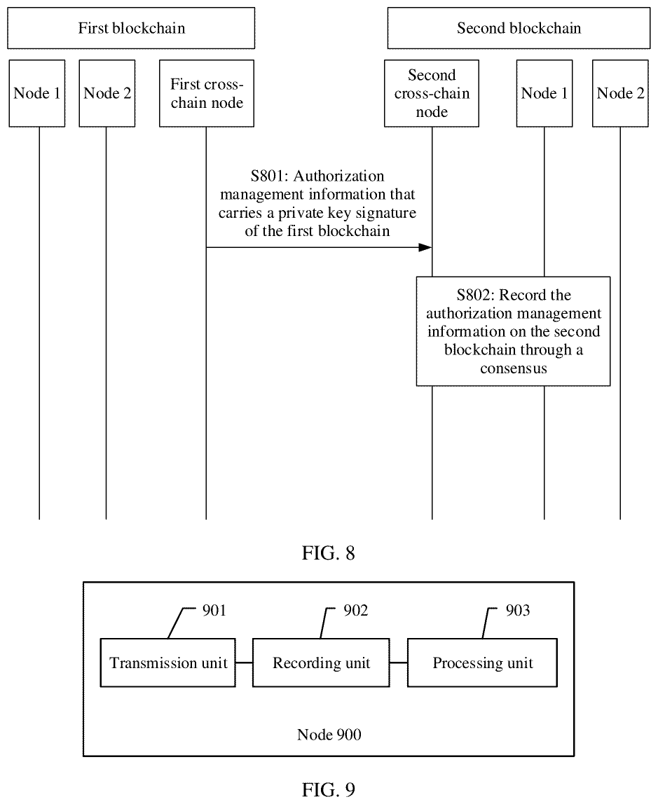

Refer to FIG. 9. FIG. 9 is a schematic diagram of a structure of a node 900 according to an embodiment of the disclosure. The node may be the foregoing first cross-chain node, or may be the foregoing second cross-chain node.

In an embodiment, the node is the first cross-chain node, and is configured to perform the method performed by the first cross-chain node in FIG. 4, FIG. 5, FIG. 6a, FIG. 7A and FIG. 7B, or FIG. 8. Specifically, the node 900 includes:
a transmission unit 901, configured to: broadcast first information to another node in a first blockchain network; and after a consensus of the another node in the first blockchain network on the first information succeeds, send first information that carries a private key signature of the first blockchain network to a second cross-chain node.

In some embodiments, the transmission unit 901 is further configured to receive second information that carries a private key signature of a second blockchain network from the second cross-chain node, where the second information is a response to the first information; and the node further includes a recording unit 902, where the recording unit 902 is configured to record the second information on a first blockchain when verification on the private key signature of the second blockchain network succeeds.

In some embodiments, the node further includes a processing unit 903, where the processing unit 903 is configured to sign the first information based on a private key of the first blockchain network, to obtain the first information that carries the private key signature of the first blockchain network.

In some embodiments, each node in the first blockchain network corresponds to a private key share of the first blockchain network, and private key shares of all nodes in the first blockchain network are combined into the private key of the first blockchain network. In the case, the processing unit 903 is configured to obtain first information that is signed by using the private key share corresponding to each node in the first blockchain network, to obtain first information that carries the private key signature of the first blockchain network.

In some embodiments, the first information is a registration request, the first information carries registration information of the first blockchain network, and the registration information includes one or more of a type of a blockchain network, a chain structure of the blockchain network, a consensus mechanism, a member admission mechanism, a genesis block state, or a smart contract in an effective state on the blockchain network.

In some embodiments, the first information is a snapshot record request, and the snapshot record request includes snapshot information of the first blockchain. The snapshot information includes one or more of a snapshot identifier, a block height represented by a snapshot, a block in which a snapshot exchange is performed, a block hash value of the block, a running node increment, an account status increment, or a smart contract increment.

In some embodiments, the processing unit 903 is further configured to invoke a smart contract to generate the first information based on one or more of a time period, a block height in the first blockchain, or a block generation speed in the first blockchain.

In some embodiments, the first information is an identity authentication request. The transmission unit 901 is further configured to receive a verification request sent by a first terminal device, where the verification request is used to verify information about a second terminal device, and the second terminal device is a terminal device that sends a connection request to the first terminal device; the verification request carries a first address that is on the second blockchain and that is of registration information of an authoritative AU institution corresponding to the second terminal device, and a second address that is on the second blockchain and that is of information that the second terminal device is endorsed by the AU institution; and the processing unit 903 is configured to generate an identity authentication request based on the verification request.

In some embodiments, the second information is that authentication of the identity authentication request succeeds or authentication of the identity authentication request fails; and the transmission unit 901 sends the second information to the first terminal device, so that the first terminal device determines, based on the second information, whether to establish a connection to the second terminal device.

In some embodiments, the first information is authorization management information, and the authorization management information includes a permission parameter of the second blockchain network; and the permission parameter of the second blockchain network is used to determine a parameter range corresponding to a smart contract deployed on the second blockchain network.

It should be noted that, for functions of functional units in the node 900 described in the embodiment of the disclosure, refer to related descriptions in the method performed by the first cross-chain node in FIG. 4, FIG. 5, FIG. 6a, FIG. 7A and FIG. 7B, or FIG. 8. Details are not described herein again.

In another embodiment, the node is the second cross-chain node, and is configured to perform the method performed by the second cross-chain node in FIG. 4, FIG. 5, FIG. 6a, FIG. 7A and FIG. 7B, or FIG. 8. Specifically, the node includes:
a transmission unit 901, configured to: receive first information that carries a private key signature of a first blockchain network from a first cross-chain node; and after verification on the private key signature of the first blockchain network succeeds, broadcast the first information to another node in a second blockchain network; and
a recording unit 902, configured to: after a consensus of the another node in the second blockchain network on the first information succeeds, record the first information on a second blockchain.

In some embodiments, the node includes a processing unit 903. The processing unit 903 is configured to generate second information based on the first information. The transmission unit 901 is configured to: broadcast the second information to the another node in the second blockchain network; and after a consensus of the another node in the second blockchain network on the second information succeeds, send second information that carries a private key signature of the second blockchain network to the first cross-chain node.

In some embodiments, the processing unit 903 is further configured to sign the second information based on a private key of the second blockchain network, to obtain the second information that carries the private key signature of the second blockchain network.

In some embodiments, each node in the second blockchain network corresponds to a private key share of the second blockchain network, and private key shares of all nodes in the second blockchain network are combined into the private key of the second blockchain network; and the processing unit 903 is further configured to obtain second information signed by using the private key share corresponding to each node in the second blockchain network, to obtain the second information that carries the private key signature of the second blockchain network.

It should be noted that, for functions of functional units in the node 900 described in the embodiment of the disclosure, refer to related descriptions in the method performed by the second cross-chain node in FIG. 4, FIG. 5, FIG. 6a, FIG. 7A and FIG. 7B, or FIG. 8. Details are not described herein again.

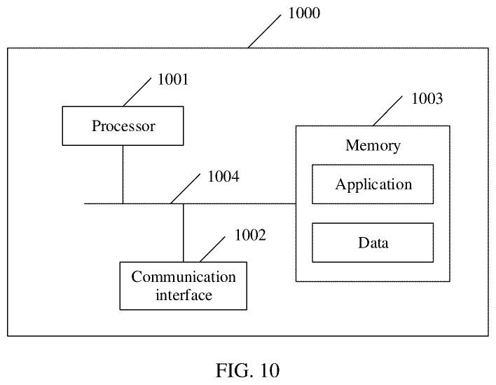

Refer to FIG. 10. FIG. 10 is a schematic diagram of a structure of a computer device according to an embodiment of the disclosure. As shown in FIG. 10, the computer device 1000 includes: a processor 1001, a communication interface 1002, and a memory 1003, where the processor 1001, the communication interface 1002, and the memory 1003 are connected to each other by using an internal bus 1004.

The processor 1001 may include one or more general-purpose processors, such as a central processing unit (CPU) or a combination of a CPU and a hardware chip. The hardware chip may be an application-specific integrated circuit (ASIC), a programmable logic device (PLD), or a combination thereof. The PLD may be a complex programmable logic device (CPLD), a field-programmable gate array (FPGA), generic array logic (GAL), or any combination thereof.

The bus 1004 may be a peripheral component interconnect (PCI) bus, an extended industry standard architecture (EISA) bus, or the like. The bus 1004 may be categorized as an address bus, a data bus, a control bus, or the like. For ease of representation, only one thick line is used to represent the bus in FIG. 10, but this does not mean that there is only one bus or only one type of bus.

The memory 1003 may include a volatile memory like a random access memory (RAM); or the memory 1003 may include a non-volatile memory like a read-only memory (ROM), a flash memory, a hard disk drive (HDD), or a solid-state drive (SSD); or the memory 1003 may include a combination of the foregoing types. Program code may be used to implement method steps performed by a computing device in the blockchain cross-chain communication method embodiment shown in FIG. 4, FIG. 5, FIG. 6a, FIG. 7A and FIG. 7B, or FIG. 8.

It should be noted that, for functions of the functional units of the computer device 1000 described in the embodiment of the disclosure, refer to related descriptions of the steps in the foregoing method embodiment in FIG. 4, FIG. 5, FIG. 6a, FIG. 7A and FIG. 7B, or FIG. 8. Details are not described herein again.

An embodiment of the disclosure further provides a computer-readable storage medium. The computer-readable storage medium stores a computer program. When the program is executed by a processor, some or all of the steps described in any one of the foregoing method embodiments may be implemented, and a function of any functional modules described in FIG. 9 may be implemented.

An embodiment of the disclosure further provides a computer program product. When the computer program product runs on a computer or a processor, the computer or the processor is enabled to perform one or more steps in any one of the foregoing methods. When the foregoing modules in the device are implemented in a form of a software functional unit and sold or used as an independent product, the modules may be stored in a computer-readable storage medium.

In the foregoing embodiments, the descriptions in embodiments have respective focuses. For a part that is not described in detail in an embodiment, refer to related descriptions in other embodiments.

It should further be understood that “first”, “second”, “third”, “fourth”, and various numbers in the specification are merely used for differentiation for ease of description, and are not construed as any limitation on the scope of the disclosure.

It should be understood that the term “and/or” in the specification describes only an association relationship between associated objects and represents that three relationships may exist. For example, A and/or B may represent the following three cases: Only A exists, both A and B exist, and only B exists. In addition, the character “/” in the specification generally indicates an “or” relationship between the associated objects.

It should be further understood that sequence numbers of the processes do not mean execution sequences in various embodiments of the disclosure. The execution sequences of the processes should be determined according to functions and internal logic of the processes, and should not be construed as any limitation on the implementation processes of embodiments of the disclosure.

A person of ordinary skill in the art may be aware that, in combination with the examples described in embodiments disclosed in the specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the disclosure.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in the disclosure, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The foregoing units described as separate parts may or may not be physically separate, and parts displayed as units may or may not be physical units, may be located in one position, or may be distributed on a plurality of network units. Some or all of the units may be selected based on actual requirements to achieve the objectives of the solutions in embodiments.

In addition, functional units in the embodiments of the disclosure may be integrated into one processing unit, each of the units may exist alone physically, or two or more units are integrated into one unit.

When the functions are implemented in a form of a software functional unit and sold or used as an independent product, the functions may be stored in a computer-readable storage medium. Based on such an understanding, the technical solutions of the disclosure essentially, or the part contributing to the technology of some approaches, or some of the technical solutions may be implemented in a form of a software product. The software product is stored in a storage medium, and includes several instructions for instructing a computer device (which may be a personal computer, a server, or a network device) to perform all or some of the steps of the methods described in embodiments of the disclosure. The foregoing storage medium includes any medium that can store program code, such as a USB flash drive, a removable hard disk, a read-only memory (ROM), a random access memory (RAM), a magnetic disk, or a compact disc.

A sequence of the steps of the method in embodiments of the disclosure may be adjusted, combined, or removed based on an actual requirement.

The modules in the apparatus in embodiments of the disclosure may be combined, divided, and deleted based on an actual requirement.

The foregoing embodiments are merely intended for describing the technical solutions of the disclosure, rather than limiting the disclosure. Although the disclosure is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of the embodiments of the disclosure.

What is claimed is:

1. An apparatus comprising a circuit, and a memory configured to store non-transitory instructions, wherein the circuit is configured execute the non-transitory instructions to thereby perform:
sending first information that includes a private key signature of a first blockchain to another apparatus in response to a consensus of another node in the first blockchain network on the first information being successful, where the first blockchain comprises the apparatus and the second blockchain comprises the another apparatus;
receiving second information that includes a private key signature of the second blockchain network, wherein the second information corresponds to the first information; and
recording the second information on the first blockchain in response to verification on the private key signature of the second blockchain network being successful.

2. The apparatus according to claim 1, wherein the circuit is further configured to execute the non-transitory instructions to thereby perform:
broadcasting the first information to the another node in the first blockchain.

3. The apparatus according to claim 1, wherein the first information is obtained by signing the first information based on a private key of the first blockchain.

4. The apparatus according to claim 1, wherein the apparatus corresponds to a private key share of the first blockchain.

5. The apparatus according to claim 4, wherein private key shares of all nodes in the first blockchain include a private key of the first blockchain.

6. The apparatus according to claim 1, wherein the circuit is further configured to execute the non-transitory instructions to thereby perform:
obtaining the first information signed by using the private key share corresponding to each node in the first blockchain, to thereby obtain the first information that includes the private key signature of the first blockchain.

7. The apparatus according to claim 1, wherein the first information comprises at least one of:
a type of the first blockchain,
a chain structure of the first blockchain,
a consensus mechanism of the first blockchain,
a member admission mechanism of the first blockchain,
a genesis block state of the first blockchain,
a smart contract in an effective state on the first blockchain,
a snapshot identifier of the first blockchain,
a block height represented by a snapshot of the first blockchain,
a block in which a snapshot exchange is performed,
a block hash value of a block of the first blockchain,
a running node increment of the first blockchain,
an account status increment of the first blockchain,
a smart contract increment of the first blockchain, or
an identity authentication request.

8. The apparatus according to claim 1, wherein the circuit is further configured to execute the non-transitory instructions to thereby perform:
invoking a smart contract to thereby generate the first information based on at least one of a time period, a block height in the first blockchain or a block generation speed in the first blockchain.

9. The apparatus according to claim 1, wherein the circuit is further configured to execute the non-transitory instructions to thereby perform:
receiving a verification request, wherein the verification request is useable to verify information about a node different from a sender of the verification request; and
generating the identity authentication request based on the verification request,
wherein the verification request includes a first address that is on the second blockchain, and that is part of registration information of an authoritative (AU) institution corresponding to the node, and a second address that is on the second blockchain, and that is of information that the node is endorsed by the AU institution

10. The apparatus according to claim 1, wherein the second information is useable to indicate that authentication of the identity authentication request succeeds or authentication of the identity authentication request fails.

11. The apparatus according to claim 1, wherein the first information comprises:
a permission parameter of the second blockchain; and
the permission parameter of the second blockchain is associated with a parameter range corresponding to a smart contract deployed on the second blockchain.

12. A method comprising:
sending first information that includes a private key signature of a first blockchain to another apparatus in response to a consensus of another node in the first blockchain network on the first information being successful, wherein the first blockchain comprises an apparatus and the second blockchain comprises the another apparatus;
receiving second information that includes a private key signature of the second blockchain network, wherein the second information corresponds to the first information; and
recording the second information on the first blockchain in response to verification on the private key signature of the second blockchain network being successful.

13. The method according to claim 12, wherein the method further comprises:
broadcasting the first information to the another node in the first blockchain.

14. The method according to claim 12, wherein the first information is obtained by signing the first information based on a private key of the first blockchain.

15. The method according to claim 12, wherein the apparatus corresponds to a private key share of the first blockchain.

16. The method according to claim 15, wherein private key shares of all nodes in the first blockchain include a private key of the first blockchain.

17. The method according to claim 12, wherein the method further comprises:
obtaining the first information signed by using the private key share corresponding to each node in the first blockchain, to thereby obtain the first information that includes the private key signature of the first blockchain.

18. The method according to claim 12, wherein the first information comprises at least one of:
a type of the first blockchain,
a chain structure of the first blockchain,
a consensus mechanism of the first blockchain,
a member admission mechanism of the first blockchain,
a genesis block state of the first blockchain,
a smart contract in an effective state on the first blockchain,
a snapshot identifier of the first blockchain,
a block height represented by a snapshot of the first blockchain,
a block in which a snapshot exchange is performed,
a block hash value of a block of the first blockchain,
a running node increment of the first blockchain,
an account status increment of the first blockchain,
a smart contract increment of the first blockchain, or
an identity authentication request.

19. The method according to claim 12, wherein the method further comprises:
invoking a smart contract to thereby generate the first information based on at least one of a time period, a block height in the first blockchain or a block generation speed in the first blockchain.

20. A non-transitory computer-readable storage medium, wherein the computer-readable storage medium is configured to store non-transitory instructions, and in response to the the non-transitory instructions being executed by a processor, thereby cause the processor to perform.
sending first information that includes a private key signature of a first blockchain to another apparatus in response to a consensus of another node in the first blockchain network on the first information being successful, wherein the first blockchain comprises an apparatus and the second blockchain comprises the another apparatus;
receiving second information that includes a private key signature of the second blockchain network, wherein the second information corresponds to the first information; and
recording the second information on the first blockchain in response to verification on the private key signature of the second blockchain network being successful.
